(19) United States
(12) Patent Application Publication
(10) Pub. No.: US 2025/0323741 A1
(43) Pub. Date: Oct. 16, 2025

(54) APPARATUS AND METHOD FOR PROVIDING DATA BROADCASTING

(71) Applicant: HYUNDAI MOBIS CO., LTD., Seoul (KR)

(72) Inventor: Yong Joon Lee, Yongin-si (KR)

(73) Assignee: HYUNDAI MOBIS CO., LTD., Seoul (KR)

(21) Appl. No.: 19/067,047

(22) Filed: Feb. 28, 2025

(30) Foreign Application Priority Data
Apr. 16, 2024 (KR) 10-2024-0050472

(51) Int. Cl. H04H 20/06; H04H 20/12

(52) U.S. Cl. CPC H04H 20/06; H04H 20/12; H04H 2201/13

(57) ABSTRACT

According to an embodiment of the present disclosure, a method of controlling an apparatus for providing data broadcasting includes receiving additional data of a radio data system, displaying the received additional data of the radio data system, storing the received additional data of the radio data system, monitoring a communication status, and transmitting the stored additional data of the radio data system according to the monitored communication status.

Pursuant to 35 U.S.C. § 119(a), this application claims the benefit of earlier filing dates and right of priority to Korean Application No. 10-2024-0050472, filed on Apr. 16, 2024, the contents of which are hereby incorporated by reference herein in their entirety.

### BACKGROUND OF THE DISCLOSURE

### Field of the Disclosure

The present disclosure is applicable to all types of apparatuses and methods for providing data broadcasting. For example, the present disclosure is applicable to a vehicle that uses radio data system (RDS)/RDS2 data, but is not necessarily limited thereto. In particular, an embodiment of the present disclosure relates to a system for recovering RDS data, and the like in an area in which analog broadcasting is not received.

### Discussion of the Related Art

A radio data system (RDS) is a technology that additionally transmits RDS additional data for data broadcasting in addition to a broadcast spectrum of frequency modulation (FM) of analog broadcast and displaying additional data such as a name of a radio broadcast station (e.g. KBS, SBS, and MBC), song title, and song lyrics.

The RDS has limitations in the amount of data to be transmitted. To overcome this, RDS2 is proposed. RDS2 allows a subcarrier added to a higher layer of an FM multiplexing method on both sidebands around a subcarrier of 57 kHz used by RDS to be repeatedly used up to three times. Therefore, it is possible to use a C-Type group with an additional data stream applied to increase a data capacity. The additional available subcarrier has 66.5 kHz, 71.25 kHz, or 76 kHz.

Data broadcasting services are provided by adding data to analog broadcasting by using RDS or RDS2. Normally, it is possible to receive RDS/RDS2 data well, but there are areas in which RDS/RDS2 data is not capable of being received in a NULL section of analog broadcasting (areas in which FM broadcasting is out of reception area).

That is, a variety of information about the current broadcast is transmitted by transmitting additional data by using FM analog data broadcasting, RDS and RDS2, but there is a serious problem in that, in a certain area (area in which FM broadcasts are not capable of being received), reception of the RDS/RDS2 broadcasting fails, resulting in restrictions in displaying related additional information (for example, inability to display on a GUI screen).

### SUMMARY OF THE DISCLOSURE

An embodiment of the present disclosure proposes a solution in which a vehicle transmits RDS/RDS2 data in a null point (an area in which radio waves are not capable of being received) and other vehicles are capable of temporarily receiving only RDS/RDS2 data in the null point of FM analog broadcast.

An embodiment of the present disclosure provides a better service to consumers and drivers in a vehicle by enabling reception of RDS and RDS2 data even in a null point (an area in which radio waves are not capable of being received).

According to an embodiment of the present disclosure, a method of controlling an apparatus for providing data broadcasting includes receiving additional data of a radio data system, displaying the received additional data of the radio data system, storing the received additional data of the radio data system, monitoring a communication status, and transmitting the stored additional data of the radio data system according to the monitored communication status.

For example, the additional data described above includes either radio data system (RDS) data or RDS2 data.

For example, the storing may include filtering duplicate data.

For example, the transmitting may include encoding the stored additional data of the radio data system.

For example, the method may further include determining whether the apparatus enters a null point based on whether a pilot signal is detected.

According to an embodiment of the present disclosure, an apparatus for providing data broadcasting includes a transceiver configured to receive additional data of a radio data system, a display configured to output the received additional data of the radio data system, a memory storing the received additional data of the radio data system, and a controller configured to monitor a communication status.

For example, the controller may be configured to control the transceiver to transmit the stored additional data of the radio data system according to the monitored communication status.

### BRIEF DESCRIPTION OF THE DRAWINGS

The drawings are provided to further understand the embodiments and illustrate embodiments together with the description related to the embodiments. For further understanding of the various embodiments described below, reference needs to be made to the following description of the embodiments in conjunction with the following drawings, in which like reference numerals refer to corresponding parts throughout the drawings.

FIG. 1 illustrates the transmission spectrum of frequency modulation (FM) broadcasting.

FIG. 2 illustrates a transmission spectrum of a radio data system (RDS)/RDS2 broadcast in more detail.

FIG. 3 illustrates an example of a certain area in which a problem with radio reception occurs.

FIG. 4 illustrates an apparatus that provides data broadcasting according to an embodiment of the present disclosure.

FIG. 5 illustrates a method of controlling an apparatus that provides data broadcasting according to an embodiment of the present disclosure.

FIG. 6 is a diagram for explaining a technical effect of enabling additional services related to RDS/RDS2 in a certain area of FIG. 3 according to an embodiment of the present disclosure, compared with the related art.

### DETAILED DESCRIPTION OF THE DISCLOSURE

Reference will now be made in detail to the embodiments of the present disclosure with reference to the accompanying drawings. The detailed description, which will be given below with reference to the accompanying drawings, is intended to explain embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Most of the terms used in the embodiments are selected from those commonly used in the field, but some terms are arbitrarily selected by the applicant and their meanings are described in detail in the following description as necessary. Therefore, the examples need to be understood based on the intended meaning of the terms and not simply the names or meanings of the terms.

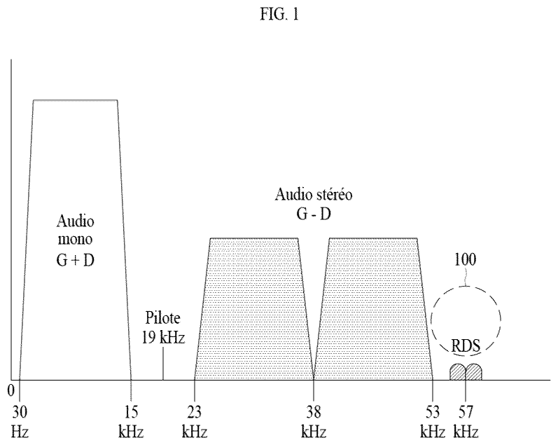

FIG. 1 illustrates the transmission spectrum of frequency modulation (FM) broadcasting.

FM broadcasting has a wider bandwidth than AM broadcasting and thus is suitable for stereo broadcasting. To simply describe the principle of FM stereo broadcasting, an L+R signal, which is obtained by combining left and right channels, a difference signal of both channels (L−R signal, also called subcarrier), and a pilot signal of 19 kHz are transmitted as a single radio wave.

Here, the L+R sum signal is referred to as a main channel, and the L−R difference signal is referred to as a subchannel.

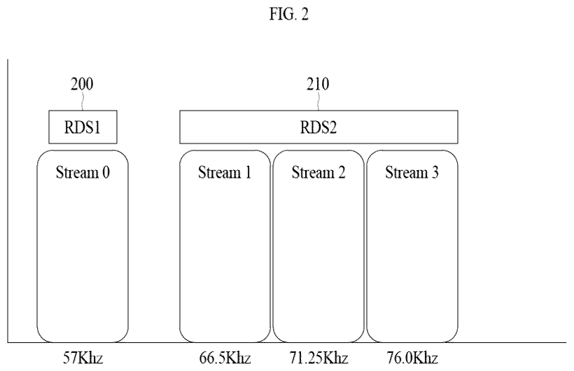

A radio data system (RDS) 100 is a technology that loads digital information in an FM broadcast signal and transmits the information and uses 57 kHz (+−6 Hz) corresponding to a third harmonic of a stereophony 19 kHz pilot tone as a subcarrier frequency. A modulation method is, for example, 2 PSK, and a data rate is 1187.5 bps (120 bytes). A RDS/RDS2 frequency is described in more detail with reference to FIG. 2 below.

FIG. 2 illustrates a transmission spectrum of an RDS/RDS2 broadcast in more detail.

As shown in FIG. 2, an RDS 200 defines a data transmission/reception frequency as 57 kHz, while an RDS2 210 defines a data transmission/reception frequency as three additional frequencies of 66.5 kHz, 71.25 kHz, and 76.0 kHz.

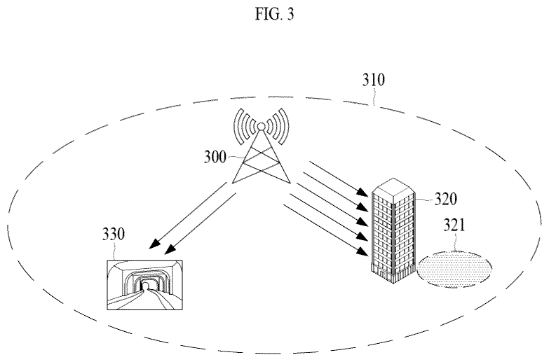

When the same data is simultaneously transmitted in Stream 0, Stream 1,Stream 2, and Stream 3 as shown in FIG. 2, data transmission efficiency decreases. Therefore, different data as possible may be transmitted. Hereinafter, a case in which a problem occurs in receiving FM broadcast in a certain area is described with reference to FIG. 3.

FIG. 3 illustrates an example of a certain area in which a problem with radio reception occurs.

A base station 300 transmits radio waves, and ideally, devices within a radio transmission area 310 receive radio waves from the base station 300.

However, there is a first FM broadcast non-reception area 321 due to a building 320. A weak electric field refers to an area in which a signal is received but there is too much noise in the signal to be recognized as a signal.

Even without the building 320, there is a second FM broadcast non-reception area 330. For example, the weak electric field corresponds a tunnel, an underpass, an underground parking lot, and a parking lot in a tall building (in which reception via multi-path is not possible).

That is, the first FM broadcast non-reception area 321 and the second FM broadcast non-reception area 330 correspond to null points.

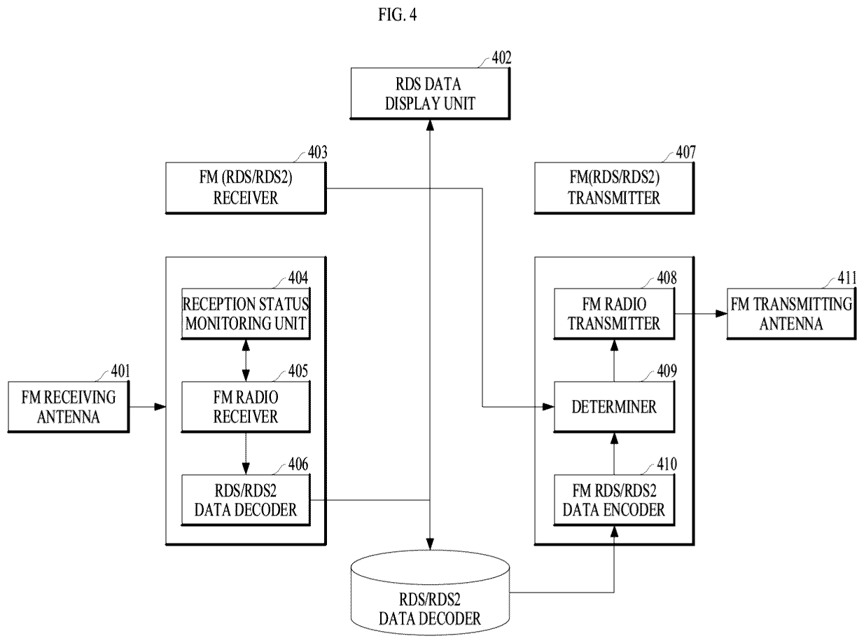

However, even in such a null point, an apparatus capable of RDS/RDS2 additional data services is described with reference to FIG. 4 below.

FIG. 4 illustrates an apparatus that provides data broadcasting according to an embodiment of the present disclosure.

As illustrated in FIG. 4, the apparatus according to an embodiment of the present disclosure includes an FM receiving antenna 401, an FM (RDS/RDS2) receiver 403, an RDS data display unit 402, an FM (RDS/RDS2) transmitter 407, and an FM transmitting antenna 411.

The FM (RDS/RDS2) receiver 403 includes a reception status monitoring unit 404, an FM radio receiver 405, and an RDS/RDS2 data decoder 406, while the FM (RDS/RDS2) transmitter 407 includes an FM radio transmitter 408, a determiner 409, and an FM RDS/RDS2 data encoder 410.

Needless to say, the present disclosure is not limited thereto and is merely an example for the convenience of description, and the scope needs to be determined according to the matters stated in the following claims.

Through the FM receiving antenna 401, an FM radio receiver 405 receives RDS/RDS2 data, and the RDS data display unit 402 outputs the RDS/RDS2 data to the RDS data display unit 402 in real time.

Simultaneously, the RDS/RDS2 data is stored in a memory in real time (e.g., the amount corresponding to about 5 to 10 minutes). When storing data, duplicate data is filtered out to minimize and update the data stored in the memory.

The reception status monitoring unit 404 monitors a reception status of radio waves in real time.

The determiner 409 determines whether an FM radio reception status is poor and determines the corresponding point as a null point based on the reception status.

The FM RDS/RDS2 data encoder 410 encodes the stored FM RDS/RDS2 data. A radio of FM radio frequency is not transmitted, and the FM radio transmitter 408 transmits only RDS/RDS2 data via the FM transmitting antenna 411.

Through this design, there is a technical effect that FM audio broadcasts are not received, but RDS/RDS2 data is transmitted, and RDS/RDS2 data is capable of being received during a temporary null point.

That is, to summarize again, a transceiver of an apparatus for providing data broadcasting according to an embodiment of the present disclosure receives additional data of a radio data system. Here, the transceiver may be, for example, the FM receiving antenna 401 shown in FIG. 4.

The display outputs the received additional data from the radio data system. Here, the display may be, for example, the RDS data display unit 402 illustrated in FIG. 4.

The memory stores the received additional data from the radio data system. Here, the memory may be, for example, an RDS/RDS2 data storage unit illustrated in FIG. 4.

The controller monitors a communication status and controls the transceiver to transmit the stored additional data of the radio data system according to the monitored communication status. Here, the controller includes, for example, at least one of the reception status monitoring unit 404 or the determiner 409 illustrated in FIG. 4. The transceiver may be, for example, the FM transmitting antenna 411 shown in FIG. 4.

The additional data described above includes, for example, either radio data system (RDS) data or RDS2 data.

The memory is additionally designed to filter duplicate data.

The controller encodes the stored additional data of the radio data system. That is, the controller may further include the FM RDS/RDS2 data encoder 410 illustrated in FIG. 4.

The controller may determine that the apparatus according to an embodiment of the present disclosure enters a null point based on whether or not a pilot signal is detected. In more detail, when a pilot signal (19 kHz) shown in FIG. 1 is not detected, the apparatus is assumed to enter the null point.

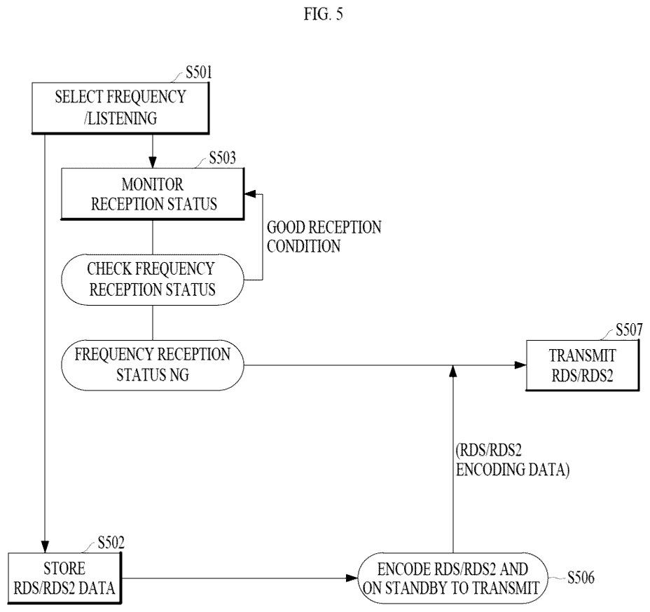

FIG. 5 illustrates a method of controlling an apparatus that provides data broadcasting according to an embodiment of the present disclosure.

According to an embodiment of the present disclosure, the apparatus for providing data broadcasting is assumed to listen to related radio after selecting a frequency (S501).

According to an embodiment of the present disclosure, the apparatus for providing data broadcasting stores RDS/RDS2 data in a memory (S502) and also monitors a reception status of radio waves (S503).

When the frequency reception status is checked (S504) and the reception status is good, the method returns to operation S503.

On the other hand, when the frequency reception status is determined to be poor (S505), the RDS/RDS2 data stored in the memory is encoded (S506) and transmitted to other external vehicles (S507).

That is, to summarize again, the apparatus for providing data broadcasting according to an embodiment of the present disclosure receives additional data of the radio data system and displays the received additional data of the radio data system.

The apparatus for providing data broadcasting according to an embodiment of the present disclosure stores the received additional data of the radio data system and monitors a communication status.

The apparatus for providing data broadcasting according to an embodiment of the present disclosure transmits the stored additional data of the radio data system according to the monitored communication status.

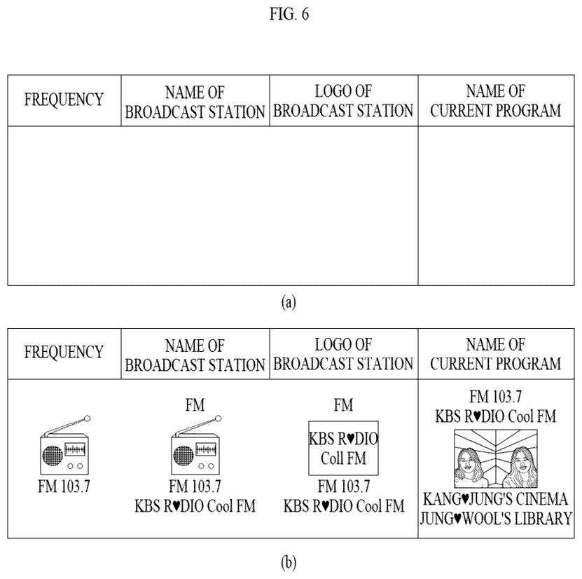

FIG. 6 is a diagram for explaining a technical effect of enabling additional services related to RDS/RDS2 in a certain area of FIG. 3 according to an embodiment of the present disclosure, compared with the related art.

According to the related art, as shown in (a) of FIG. 6, when a vehicle or the like enters a null point with poor communication status, RDS/RDS2 data is not received, and thus additional data such as the name of a radio broadcast station, song title, and song lyrics are not displayed at all.

On the other hand, according to the embodiment of the present disclosure described above, as shown in (b) of FIG. 6, even when a vehicle or the like enters a null point with poor communication status, it is possible to receive RDS/RDS2 data from another vehicle, and thus there is a technical effect in which additional data such as the name of a radio broadcast station, a song title, and song lyrics are displayed normally.

Embodiments have been described from the method and/or device perspective, and descriptions of methods and devices may be applied so as to complement each other.

Although the accompanying drawings have been described separately for simplicity, it is possible to design new embodiments by merging the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications can be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same. Executable instructions for performing the method/operations of the device according to the embodiments may be stored in a non-transitory CRM or other computer program products configured to be executed by one or more processors, or may be stored in a transitory CRM or other computer program products configured to be executed by one or more processors.

In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “/” and “,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

The operations according to the above-described embodiments may be performed by the transmission device and/or the reception device according to the embodiments. The transmission/reception device includes a transmitter/receiver configured to transmit and receive media data, a memory configured to store instructions (program code, algorithms, flowcharts and/or data) for a process according to embodiments, and a processor configured to control operations of the transmission/reception device.

The processor may be referred to as a controller or the like, and may correspond to, for example, hardware, software, and/or a combination thereof. The operations according to the above-described embodiments may be performed by the processor.

In the case of FM broadcasting, duplication is impossible because the audio data changes in real time. However, RDS/RDS2 data repeatedly transmits the same data for a certain period of time, and thus according to an embodiment of the present disclosure, FM RDS/RDS2 data is output at a low output such that additional data services may be temporarily maintained in a null point.

In more detail, when traveling by car, in urbanized and mountainous areas, FM broadcasts may not be received in various spaces such as high-rise buildings (which may result in poor reception quality due to multipaths), underground parking spaces, underground passageways, and tunnels in downtown areas, and in mountainous areas, there may be areas in which reception is not possible due to the transmission power of the radio waves themselves and the mountains.

In such areas, there are technological effects that may overcome the failure to receive disaster broadcasts, important information (data), as well as the limitations on information displayed to consumers while driving.

What is claimed is:

1. A method of controlling an apparatus for providing data broadcasting, the method comprising:
receiving additional data of a radio data system by a transceiver;
displaying the received additional data of the radio data system on a display;
storing the received additional data of the radio data system in a memory;
monitoring a communication status by a controller; and
transmitting the stored additional data of the radio data system according to the monitored communication status using a transmitter.

2. The method of claim 1, wherein the additional data comprises any one of radio data system (RDS) data or RDS2 data.

3. The method of claim 1, wherein the storing includes filtering duplicate data using a processor.

4. The method of claim 1, wherein the transmitting includes encoding the stored additional data of the radio data system using a processor.

5. The method of claim 1, further comprising determining whether the apparatus enters a null point based on whether a pilot signal is detected using a processor.

6. An apparatus for providing data broadcasting, the apparatus comprising:
a transceiver configured to receive additional data of a radio data system;
a display configured to output the received additional data of the radio data system;
a memory storing the received additional data of the radio data system; and
a controller configured to monitor a communication status,
wherein the controller is configured to control the transceiver to transmit the stored additional data of the radio data system according to the monitored communication status using a processor.

7. The apparatus of claim 6, wherein the additional data comprises any one of radio data system (RDS) data or RDS2 data.

8. The apparatus of claim 6, wherein the memory is configured to filter duplicate data using the processor.

9. The apparatus of claim 6, wherein the controller further includes an encoder configured to encode the stored additional data of the radio data system using the processor.

10. The apparatus of claim 6, wherein the controller is configured to determine whether the apparatus enters a null point based on whether a pilot signal is detected using the processor.
